(19) United States
(12) Patent Application Publication
(10) Pub. No.: US 2006/0271877 A1
(43) Pub. Date: Nov. 30, 2006

(54) A SYSTEM AND METHODS FOR SELECTIVE SHARING OF AN APPLICATION WINDOW

(75) Inventor: David Frederic Theurer, Santa Barbara, CA (US)

Correspondence Address: CHOATE, HALL & STEWART LLP, TWO INTERNATIONAL PLACE, BOSTON, MA, 02110, US

(73) Assignee: CITRIX SYSTEMS, INC., Fort Lauderdale, FL (US)

(21) Appl. No.: 10/908,762

(22) Filed: May 25, 2005

(51) Int. Cl. G06F 9/00; G06F 17/00

(52) U.S. Cl. 715/781

(57) ABSTRACT

A method of selective sharing of an application window includes the step of selecting, at a source node, a first application window for sharing with at least one consumer node. A determination is made that a second window obscures at least some of the first application window. The first window is displayed on at least one consumer node, unobscured by the second window.

### FIELD OF THE INVENTION

The present invention relates to a method and system for application sharing and, in particular, to a system and methods for selective sharing of an application window.

### BACKGROUND OF THE INVENTION

FIG. 1A depicts a screen shot of a display generated by a conventional system enabling a user of one computer system to share displays and presentation of application windows with a user of another computer system. Presentation protocols enable transferring display data from one computer to another. In FIG. 1A, a user of a source node 100 shares display data representing a desktop environment 102 with a user of a consumer node 150. In brief overview, the source node 100 shows the display data representing the desktop environment 102 to the user of the source node. The consumer node 150 shows display data representing the desktop environment 151 to a user of the consumer node 150. The desktop environment 151 includes an application window 152 that displays the shared desktop environment 102 to the user of the consumer node 150. The source node 100 and the consumer node 150 are described in greater detail in FIGS. 1C, 2A and 2B.

The user of the source node 100 may choose to share a display of a particular application window with the user of the consumer node 150. In some embodiments, the user of the source node 100 shares a plurality of application windows that form a desktop environment 102. In other embodiments, the user of the source node 100 shares a display of a plurality of desktop environment elements, such as icons, taskbars, and menus with the user of the consumer node 150. In one embodiment, the user of the source node 100 chooses to share the display of an application window or a desktop environment element to enable collaboration with the user of the consumer node 150. In another embodiment, the user of the source node 100 chooses to share the display to enable training or troubleshooting.

FIG. 1B is a screen shot of an embodiment of display data presented to both a user of a source node 100 and a user of a consumer node 150. In brief overview, the screen shot depicts a desktop environment 102 displayed on a source node 100 and a desktop environment 151 displayed on a consumer node 150.

In some embodiments, the desktop environment 102 on the source node 100 includes an application window 104. In one of these embodiments, the source node 100 shares with the consumer node 150 every desktop environment element and every application window displayed in desktop environment 102. The consumer node 150 may display the shared desktop environment 102 to the user in an application window 155, located within the desktop environment 151. In another of these embodiments, the application window 155 displays only the shared application window 104. The application window 155 may be located within the desktop environment 151. The application window 155 may also be displayed as a nested window located within an application window 152.

Conventional systems such as those depicted by FIGS. 1A and 1B do not typically allow for selective sharing of only a particular window or windows, or for the exclusion of other desktop elements. Typically in these embodiments, an entire desktop environment 102 is shared and the user of the source node 100 may have no control over the application windows shared with the consumer node 150. As a result, the user of the source node 100 is typically unable to prevent the display of an application window 106 when the application window 106 interrupts a presentation of display data to the consumer node 150. As shown in FIG. 1B, depiction of the application window 156, containing a text message to the user of the source node 100 in this embodiment, disrupts the presentation of application window 104 to the user of the consumer node 150. Some systems attempt to solve these problems by covering new application windows with a solid colored block. However, a new window appearing as a large object with a colored block layered on top of it may still result in confusion or distraction for users, as well as decreasing the amount of space available for display of relevant material on a screen.

Presentation of irrelevant materials by the intruding application window 156 may distract from the presentation of display data to the consumer node 150, or confuse a user of the consumer node 150. Display of an intruding application window 156 may also cause inappropriate distribution of sensitive data to the consumer node 150. A method is desirable for enabling selective sharing of application windows by a user while providing privacy to the user and maintaining confidentiality of application windows not selected for sharing. Additionally, it would be desirable for such a method to minimize viewer confusion or distraction.

### BRIEF SUMMARY OF THE INVENTION

The present invention relates to a system and methods for selective sharing of an application window.

In one aspect, the invention relates to a method for selective sharing of an application window. A source node selects a first application window for sharing with at least one consumer node. A determination is made that a second application window obscures at least some of the first application window. The first application window, unobscured by the second application window, is displayed on the at least one consumer node.

In one embodiment, a portion of a desktop environment is selected at the source node for sharing with at least one consumer node. In another embodiment, a second application window is selected at the source node for sharing with the at least one consumer node, the second application window comprising a window owned by the first application window. In still another embodiment, the second application window does not obscure the first application window in the display to the at least one consumer node because the second application window is not displayed.

In another aspect, the invention relates to a method of selective sharing of an application window. A source node selects a first application window to share with at least one consumer node. The source node identifies a change in display data associated with the first application window. The source node detects that the change includes display data associated with a second application window. The source node determines that the second application window is not selected for sharing with the at least one consumer node. The source node determines not to generate a data packet representing the change.

In some embodiments, the source node selects a plurality of application windows to share with at least one consumer node, the plurality of application windows forming a desktop environment. In one embodiment, the source node detects that the second application window has a window identifier different from a window identifier of the first application window. In another embodiment, a determination is made as to whether a change to display data associated with a second application window collides with a change to display data associated with the application window. In still another embodiment, an indication is made to a user of the source node that the presentation of display data associated with the application window is paused. In some embodiments, a data packet is generated responsive to a determination that the change associated with the second application window is selected for sharing with the at least one consumer node.

In another aspect, the invention relates to a system for selective sharing of an application window, including a capture engine, a collision detector, and a packet generator. The capture engine identifies a change to a set of display data associated with an application window and stores the set of display data. The collision detector, in communication with the capture engine, determines whether a change to the set of display data includes display data associated with a second application window and determines whether the second application window is selected for sharing. The packet generator generates a data packet representing the change to the set of display data.

In one embodiment, the capture engine captures a section of a screen displayed to a user of the node. In another embodiment, the collision detector requests generation of a data packet from the packet generator if a change associated with the application window comprises data associated with the application window. In still another embodiment, the collision detector requests generation of a data packet from the packet generator if a change associated with the application window comprises display data associated with the application window and a second application window selected for sharing. In yet another embodiment, a third application window displays a frame around the first application window to indicate to a user of the node that the first application window is selected for sharing.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a screen shot of an embodiment in which a user of a source node shares display data with a user of a consumer node;

FIG. 1B is a screen shot of an embodiment of display data presented to both a user of a source node and a user of a consumer node;

FIG. 1C is a diagrammatic view of one embodiment of a networked system having multiple consumer nodes in communication with a source node;

FIGS. 2A and 2B are block diagrams depicting embodiments of computers useful in connection with the present invention;

FIG. 3 is a flow diagram of one embodiment of the steps taken to selectively share display data representing an application window;

FIG. 4A is a screen shot of an embodiment of an apparatus enabling a user of a source node to select an application window for sharing;

FIG. 4B is a screen shot depicting an embodiment of an apparatus enabling a user of a source node to select an application window for sharing;

FIG. 4C is a screen shot of an embodiment of an apparatus enabling a user of a second source node to select an application window to share with a user of a consumer node;

FIG. 5 is a flow diagram depicting in greater detail one embodiment of the steps taken to selectively share display data representing an application window;

FIG. 6A is a screen shot depicting an embodiment in which a user of a source node has used an apparatus to select a particular window for sharing;

FIG. 6B is a screen shot of an embodiment of a display indicating to a user of a source node which application window is selected for sharing;

FIG. 6C is a screen shot depicting a display to a user of a source node indicating to the user that selecting a minimized application window will initiate sharing of the application window;

FIG. 6D is a screen shot of an embodiment of a display to a user of a source node of a first application window and an indication that the first application window is selected for sharing, and depicting a display of a shared first application window to a user of a consumer node;

FIG. 6E is a screen shot depicting an embodiment of an apparatus enabling a user of a source node to set sharing preferences when sharing an application window;

FIG. 6F is a screen shot depicting a display to a user of a consumer node after a user of a source node has closed a shared application window;

FIG. 7 is a block diagram depicting one embodiment of a system for selective sharing of an application window;

FIG. 8A is a screen shot of an embodiment of a display indicating to a user of a source node that an entire desktop is selected for sharing;

FIG. 8B is a screen shot of an embodiment of a display indicating to a user of a source node that a modified form of the entire desktop is selected for sharing;

FIG. 8C is a screen shot of an embodiment of a display to a user of a source node in which the entire desktop is displayed but in which only a modified form of the entire desktop is depicted to a user of a consumer node;

FIG. 9A is a screen shot depicting an embodiment of a desktop environment displaying an application window on a source node and of a desktop environment displaying the shared application window on a consumer node; and

FIG. 9B is a screen shot depicting a display of a desktop environment displaying an obscured application window on a source node and of a desktop environment displaying an unobscured application window on a consumer node.

### DETAILED DESCRIPTION OF THE INVENTION

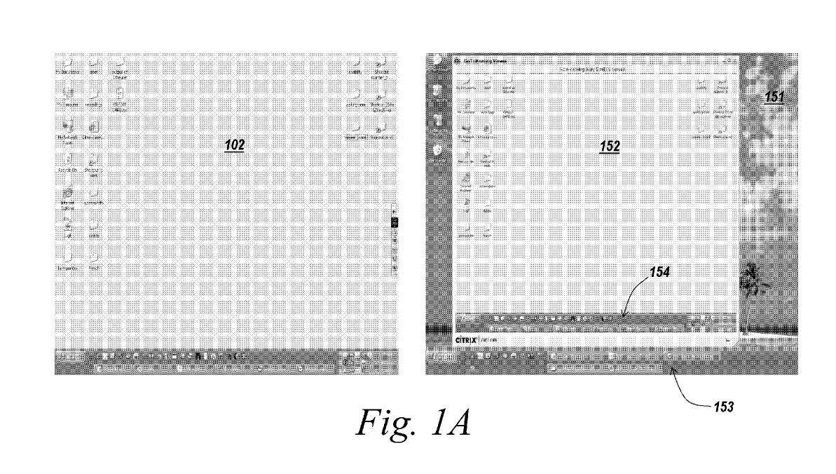

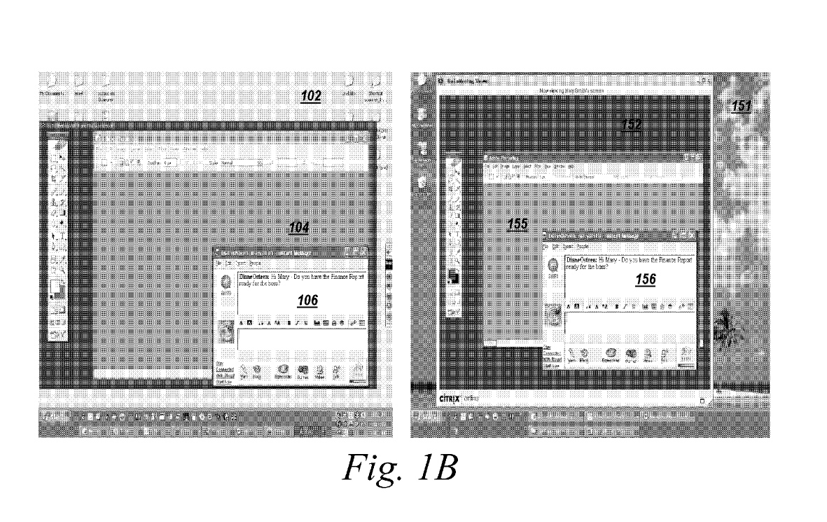

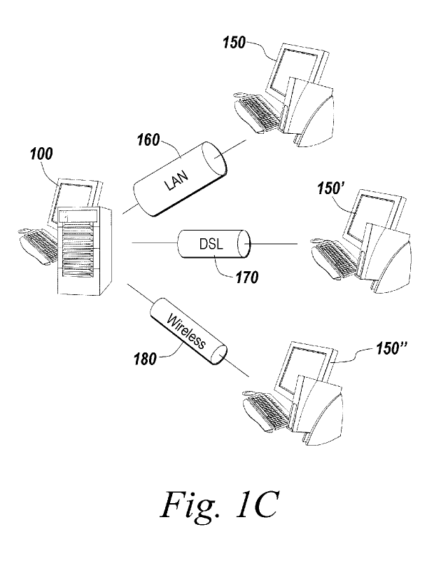

Referring now to FIG. 1, a networked system having a source node 100 in communication with a number of consumer nodes 150, 150′, 150″ is depicted. In some embodiments, the source node 100 may be referred to as a host node 100. As shown in FIG. 1, the consumer nodes 150, 150′, 150″ may communicate with the source node 100 via networks of differing bandwidth. In the embodiment shown in FIG. 1C consumer node 150 communicates with the source node 100 via a high-bandwidth network 160, such as a local area network (LAN). Consumer node 150″ communicates with the source node 100 via a low-bandwidth network 180, such as a wireless network. Consumer node 150′ communicates with the source node 100 via a network 170 having bandwidth between the low-bandwidth network 180 and the high-bandwidth network 160, such as a Digital Subscriber Line (DSL) connection. Although only one source node 100 and three consumer nodes 150, 150′, 150″ are depicted in the embodiment shown in FIG. 1C, it should be understood that the system may provide multiple ones of any or each of those components. For example, in one embodiment, the system includes multiple, logically-grouped source nodes 100, each of which may be available to provide data to a consumer node 150, 150′, 150″. In these embodiments, the logical group of source nodes 100 may be referred to as a “server farm” or “content farm.” In other embodiments, the source node 100 is a multi-user server having a virtual frame buffer, i.e., a presentation server.

The network connections 160, 170, 180 between the consumer nodes 150, 150′, 150″ and the source node 100 can be local area networks (LAN), metropolitan area networks (MAN), or a wide area network (WAN) such as the Internet. The source node 100 and the consumer nodes 150, 150′, 150″ may connect to the networks 160, 170, 180 through a variety of connections including standard telephone lines, LAN or WAN links (e.g., T1, T3, 56 kb, X.25), broadband connections (ISDN, Frame Relay, ATM), and wireless connections. Connections between the source node 100 and the consumer nodes 150, 159′, 150″ may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections). Although shown in FIG. 1 as separate networks, networks 160, 170, 180 may be combined in a single physical network.

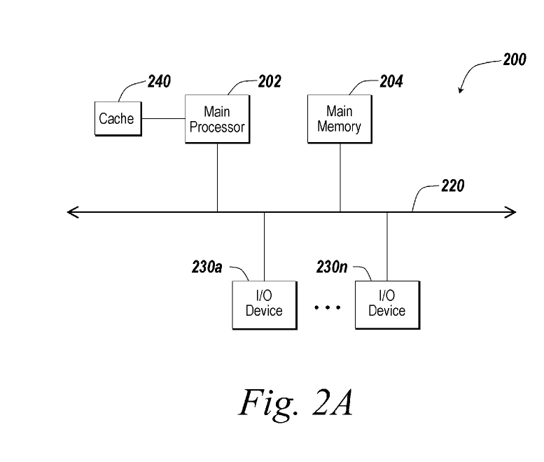

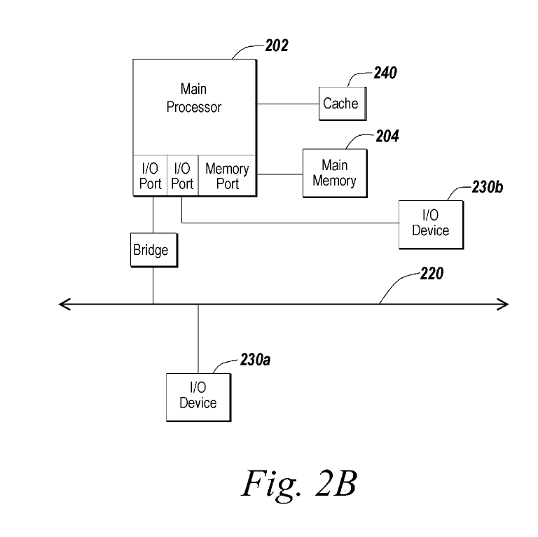

In some embodiments, the source node 100 and the consumer nodes 150, 150′, 150″ are provided as personal computers or computer servers, of the sort manufactured by the Hewlett-Packard Corporation of Palo Alto, Calif. or the Dell Corporation of Round Rock, Tex. FIGS. 2A and 2B depict block diagrams of a typical computer 200 useful as the source node 100 and the consumer nodes 150, 150′, 150″. As shown in FIGS. 2A and 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, Pentium III, Pentium IV, Pentium M, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 00 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

In some embodiments the consumer node 150, 150′, 150″ is a mobile device, such as a JAVA-enabled cellular telephone or personal digital assistant (PDA), such as the i55sr, i58sr, i85s, i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In other embodiments in which the consumer node 150 is mobile, it may be a personal digital assistant (PDA), such as the Tungsten W, the VII, the VIIx, the i705, or a combination PDA/telephone device such as the Treo 180, Treo 270, Treo 600, or Treo 650 all of which are manufactured by palmOne, Inc. of Milpitas, Calif.

In these embodiments, the consumer nodes 150, 150′, 150″ connect to the source node 100 using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

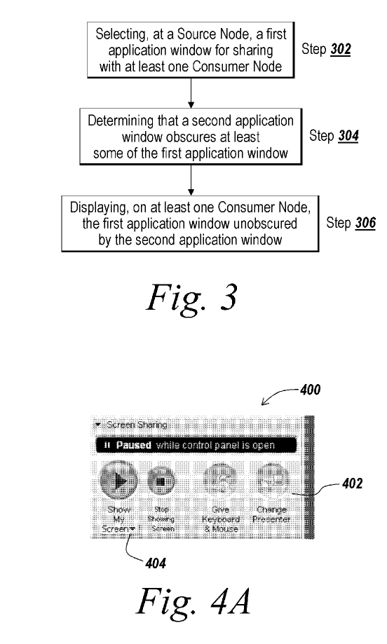

FIG. 3 is a flow diagram of one embodiment of the steps taken to selectively share display data representing an application window. In brief overview, a source node 100 selects a first application window for sharing with at least one consumer node (step 302). A determination is made that a second application window obscures at least some of the first application window (step 304). The first application window is depicted unobscured by the second application window on the at least one consumer node (step 306).

A source node 100 selects a first application window for sharing with at least one consumer node 150 (step 302). In some embodiments, a user of the source node 100 selects the first application window for sharing from a list of available application windows. In one of these embodiments, a selection menu 306 presents this list to the user of the source node 100.

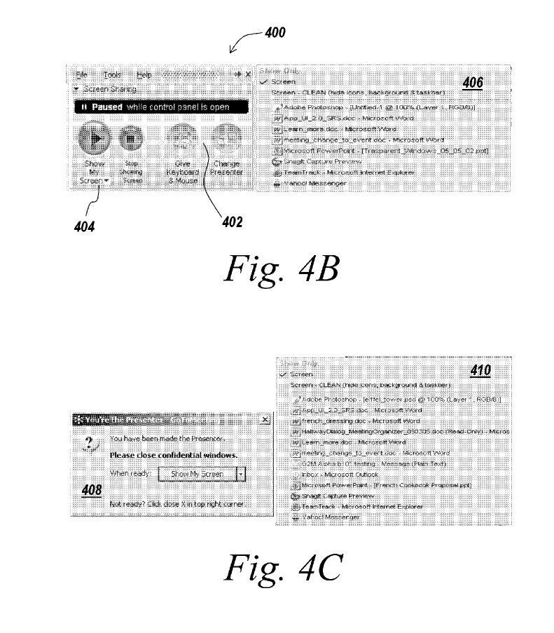

Referring ahead, FIG. 4A depicts a screen shot of an embodiment of an apparatus enabling a user of a source node 100 to select an application window for sharing with at least one consumer node 150. In brief overview, a control panel 400 includes a toolbar 402 and a menu 404. In one embodiment, the tool bar 402 enables the user of the source node 100 to start a presentation of a screen, depicted in FIG. 4A by a play button. In another embodiment, the tool bar 402 enables the user to stop the presentation of the screen, depicted in FIG. 4A by a stop button. In still another embodiment, the tool bar 402 enables the user to select a user of a consumer node 150 to control the presentation of the screen, depicted in FIG. 4A by a button labeled “Give Keyboard & Mouse” and a button labeled “Change Presenter.”

In some embodiments, the menu 404 enables a user of a source node 100 to select an application window for sharing. In one of these embodiments, the default setting of the menu 404 indicates that the user will share an entire screen displayed on the source node 100 with a consumer node 150. Sharing the entire screen may result in presentation to the consumer node 150 of all application windows displayed by the source node 100, as well as presentation of a plurality of desktop environment elements, such as desktop icons, task bars, and menus. In some embodiments, the application windows displaying on the source node 100 form a desktop window environment.

In another embodiment where a user of the source node 100 selects the first application window for sharing from a list of available application windows, the user of the source node 100 selects a second application window for sharing with the at least one consumer node 150, the second application window being owned by the first application window. In one embodiment, the user explicitly selects the second application window for sharing by selecting the application from a list as discussed above. In another embodiment, when the user selects a first application window for sharing, a second application window owned by the first application window is automatically chosen for sharing, even without explicit selection by the user.

In still another embodiment where a user of the source node 100 selects the first application window for sharing from a list of available application windows, the selection menu enables the user of the source node 100 to select a portion of a desktop for sharing with at least one consumer node 150, as depicted in FIG. 4B and FIG. 4C.

FIG. 4B depicts in a screen shot an embodiment of an apparatus enabling a user of a source node 100 to select an application window for sharing with at least one consumer node 150. In one embodiment, when the user selects the menu 404, a selection menu 406 appears. In another embodiment, when a user selects the play button in the toolbar 402, the selection menu 406 appears.

In some embodiments, the selection menu 406 lists a plurality of application windows displayed by the source node 100. In one of these embodiments, the user of the source node 100 may select one of the plurality of application windows to share with a consumer node 150. In another of these embodiments, the user of the source node 100 may select a subset of the plurality of application windows displayed by the source node 100. In still another of these embodiments, the user of the source node 100 may select a subset of the plurality of application windows and exclude a second subset of the plurality of application windows.

In other embodiments, the selection menu 406 enables the user to indicate that all application windows displayed on the source node 100 should be shared with the consumer node 150. In still other embodiments, the selection menu 406 enables the user to indicate that a modified form of the desktop displayed on the source node 100. In one of these embodiments, the modified form of the desktop blocks display of a plurality of desktop elements including icons, background, or taskbars to the consumer node 150.

FIG. 4C is a screen shot of an embodiment of an apparatus enabling a user of a second source node 100′ to select an application window to share with a user of at least one consumer node 150. In one embodiment, the user of the source node 100 uses the tool bar 402 to enable a user of a second source node 100′ to control a presentation of a screen. In some embodiments, the user of the source node 100 enables a user of a consumer node 150 to control the presentation of the screen. In one of these embodiments, the consumer node 150 functions as a source node 100.

When the user of the source node 100 selects the user of the second source node 100 to control the presentation of the screen, the user of the second source node 100 receives a display 408. In one embodiment, the display 408 enables the user of the second source node 100 to use a selection menu 410 to select an application window to share with at least one consumer node 150. In some embodiments, the selection menu 410 is substantially similar to the selection menu 406 and presents to the user of the second source node 100 a listing of a plurality of application windows displaying on the second source node 100′.

Referring back to FIG. 3, a determination is made that a second application window obscures at least some of the first application window (step 304). In some embodiments, a set of display data representing the first application window is captured for transmission to the consumer node 150. In one of these embodiments, the source node 100 verifies that only display data associated with the first application window is transmitted to the consumer node 150. In another of these embodiments, the source node 100 determines that the display data is also associated with the second application window, which obscures display of at least a portion of the first application window. In some embodiments, the second application window displays an incoming message, such as an email or text message, and was not requested by the user of the source node 100. In other embodiments, the second application window displays material inappropriate for sharing, such as information irrelevant to the purpose for sharing the first application window, confidential or sensitive information, or information personal to the user of the source node 100.

The first application window is depicted unobscured by the second application window on the at least one consumer node 150 (step 306). In some embodiments, the second application window is not displayed to the at least one consumer node 150. In one of these embodiments, the source node 100 does not transmit display data associated with the second application window. In other embodiments, the second application window is displayed to the user of the source node 100 who may choose to display the second application window. In still other embodiments, the second application window is associated with the first application window and is displayed. In one of these embodiments, a data packet is generated to transmit the display data associated with the second application window to the consumer node 150.

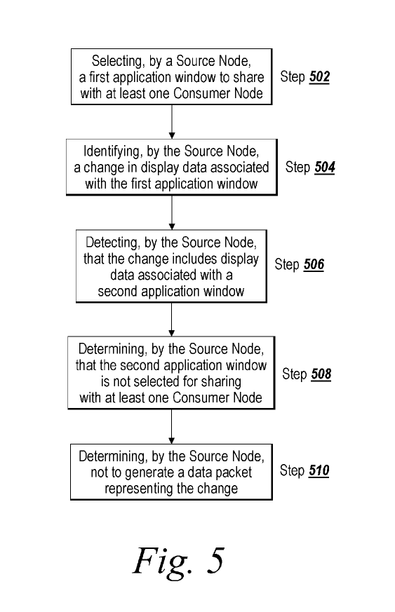

FIG. 5 is a flow diagram depicting in greater detail one embodiment of the steps taken to selectively share display data representing an application window. In brief overview, a source node 100 selects a first application window to share with at least one consumer node 150 (step 502). The source node 100 identifies a change in display data associated with the first application window (step 504). The source node 100 detects that the change includes display data associated with a second application window (step 506). The source node 100 determines that the second application window is not selected for sharing with the at least one consumer node 150 (step 508). The source node 100 determines not to generate a data packet representing the change (step 510).

A source node 100 selects a first application window to share with at least one consumer node 150 (step 502). In one embodiment, a user of the source node 100 selects the first application window. In some embodiments, a selection menu 406 presents this list to the user of the source node 100.

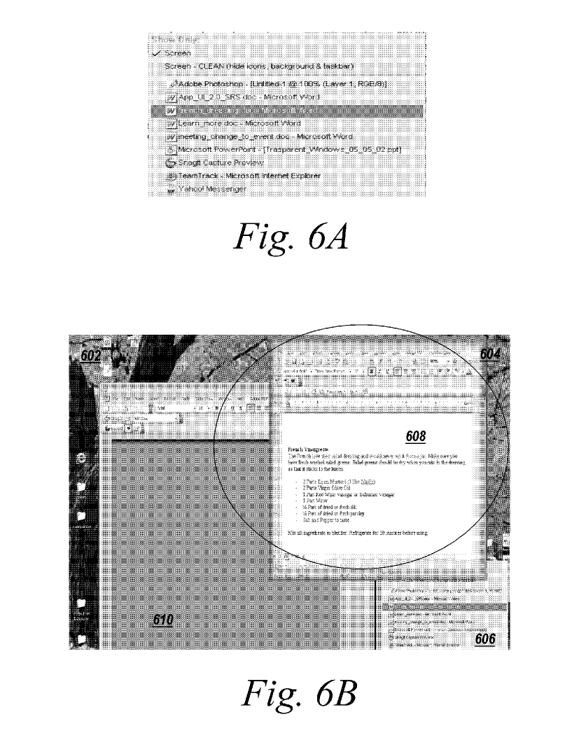

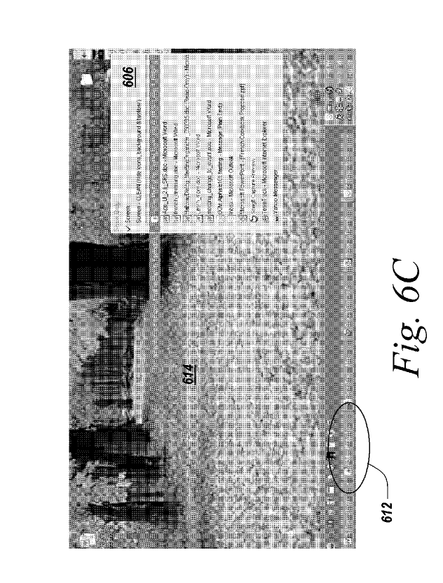

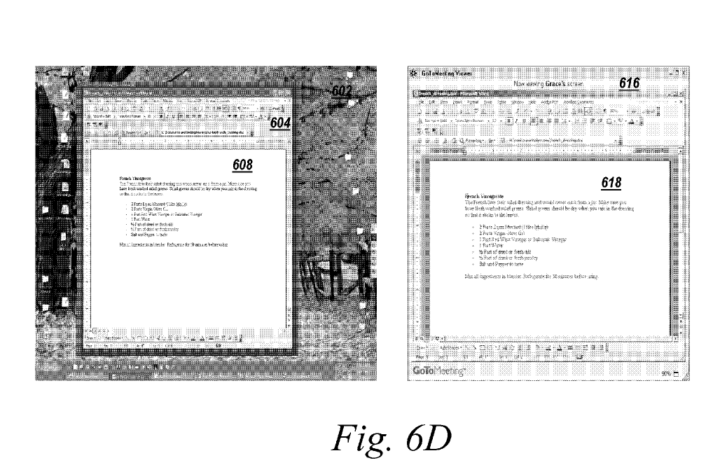

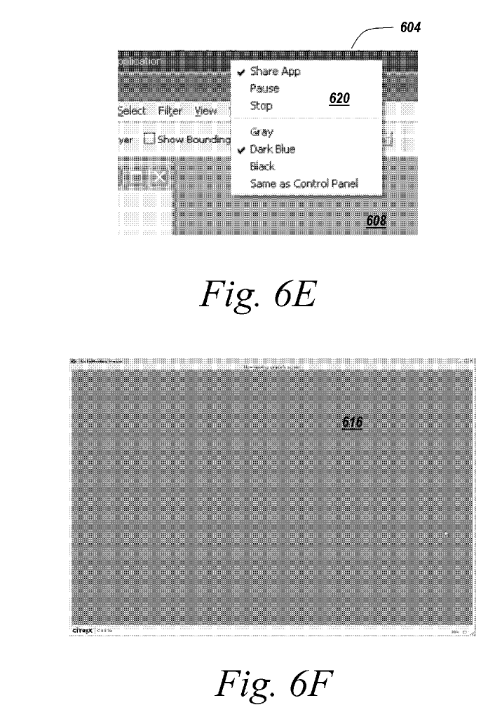

Referring ahead, FIG. 6A depicts a screen shot of an embodiment in which a user of a source node 100 has used an apparatus to select a particular window for sharing. In one embodiment, a display of a pull down menu enables a user of a source node 100 to select a particular window for sharing with at least one consumer node 150. In an embodiment depicted in FIG. 6A, the user has selected an application window displaying a Microsoft Word document entitled “French_dressing.doc.” In some embodiments, a graphical user interface element, such as a checkmark, will appear to the left of the selected item to identify for the user the application window selected for sharing.

FIG. 6B is a screen shot of an embodiment of a display indicating to a user of a source node 100 an application window selected for sharing. In one embodiment, the user of the source node 100 selects an application window from a list of a plurality of application windows shown in a selection menu 606. In some embodiments, the list of the plurality of application windows shown in the selection menu 606 includes all of the application windows displayed to the user of the source node 100 in a desktop environment 602. In one of these embodiments, the desktop environment 602 includes application windows 604, 608, and 610, as well as desktop environment elements such as desktop icons, taskbars, and background images. In an embodiment depicted by FIG. 6B, the user of the source node 100 has selected an application window 608 displaying a Microsoft Word document entitled “French_dressing.doc” for sharing with at least one consumer node 150.

In one embodiment, when the user selects a name of the application window 608 from the selection menu 606, a third window 604 is associated with the application window 608 and both the third window 604 and the application window 608 display to the user. In some embodiments, the third window 604 displays the frame around the application window 608 when the user highlights the name of the application window 608 in the selection menu 606, before the user completes selection of the application window 608.

In some embodiments, the third window 604 displays a frame surrounding the application window 608. In one of these embodiments, the frame distinguishes the application window 608 from any other application windows displayed to the user, such as application window 610, and indicates to the user the application window the user selected. In another of these embodiments, a transparent frame is displayed and over a short period of time the level of opacity of the frame increases. In still another of these embodiments, the level of opacity of the frame increases and decreases, creating a pulsing effect around the application window 608.

In some embodiments, selecting an application window 608 for sharing results in the display of only that application window 608 to a consumer node 150. In one of these embodiments, the selection of the application window 608 for sharing indicates to the source node 100 that no other application window 610 should be presented to the consumer node 150 and the source node 100 blocks transmission of display data associated with any window other than the selected application window 608.

FIG. 6C is a screen shot depicting a display to a user of a source node 100 indicating that selecting a minimized application window will initiate sharing of the application window. In one embodiment, the display presents a message in a text box to the user. In some embodiments, when the user chooses to maximize a minimized application window 612, the selection menu 606 is displayed to the user with a text box 614. In one of these embodiments, the text box 614 replaces the third application window 504 in indicating to the user that an application window is selected for sharing.

Referring back to FIG. 5, the source node 100 identifies a change in display data associated with the first application window (step 504). In some embodiments, the source node 100 monitors the display presented to the user for changes. When a change occurs, such as creation of a new application window, destruction of an existing application window, or relocation of an existing application window, the source node 100 identifies the change. In one embodiment, the source node 100 analyzes the display data representing the change to determine whether to transmit the change to the consumer node 150.

The source node 100 detects that the change includes display data associated with a second application window (step 506). In some embodiments, the source node 100 detects that the display data is associated with a window having a window identifier different from a window identifier of the first application window. In one of these embodiments, identifying a different window identifier indicates that the display data is associated with the second application window. In other embodiments, the source node 100 determines whether a change to display data associated with the second application window collides with the change to display data associated with the application window.

The source node 100 determines that the second application window is not selected for sharing with the at least one consumer node 150 (step 508). In one of these embodiments, the source node 100 makes this determination responsive to an examination of input received from the user via the selection menu. In another of these embodiments, the user may have explicitly identified the second application window as a window not to be shared with the consumer node 150.

The source node 100 determines not to generate a data packet representing the change (step 510). The determination not to generate the data packet may enable the source node 100 to prevent the second application window from displaying on the consumer node 150. The source node 100 may continue to transmit display data associated only with the first application window to the consumer node 150. In some embodiments, the source node 100 ceases transmission of display data associated with the first application window until display data associated only with the first application window is available for sharing with the consumer node 150. In one of these embodiments, this results in a pausing of a presentation of display data from the source node 100 to the consumer node 150. In another of these embodiments, the source node 100 indicates to the user of the source node 100 that the presentation of display data associated with the application window is paused.

In some embodiments, the source node 100 does generate the data packet, responsive to a determination that the change associated with the second application window is selected for sharing with the at least one consumer node 150. In one of these embodiments, the user of the source node 100 has selected the second application window for sharing. In another of these embodiments, the first application window created the second application window, making it a window owned by the first application window, and the second application window is automatically selected for sharing because of its association with the first application window.

Referring now to FIG. 6D, a screen shot depicts an embodiment of a display to a user of a source node 100 of a first application window and an indication that the first application window is selected for sharing, and depicting a display of a shared first application window to a user of a consumer node 150. The desktop environment 602 depicts an embodiment of a screen displayed to the user of the source node 100. In one embodiment, the third application window 604 is displayed as a frame around the application window 508. The third application window 604 indicates to the user of the source node 100 that the application window 608 is selected for sharing with the consumer node 150.

In one embodiment, a window 616, displayed on the consumer node 150, contains all application windows displaying to the consumer node 150 from the source node 100. In an embodiment depicted by FIG. 6D, an application window 618 displays to the consumer node 150 the contents of the application window 608. In one embodiment, selection of application window 608 for sharing excludes from display on the consumer node 150 any other window or desktop element displaying in desktop environment 602 on the source node 100.

In FIG. 6E, a screen shot depicts an embodiment of an apparatus enabling a user of a source node 100 to set sharing preferences when sharing an application window. In brief overview, the screen shot depicts a third application window 604, a shared application window 608, and a preferences menu 620.

In one embodiment, the third application window 604 provides the user of the source node 100 with an interface for modifying sharing preferences. In another embodiment, the third application window 604 provides the user with a pull down menu displayed when the user right-clicks on the third application window 604. In still another embodiment, the third application window 604 provides the user with an interface selected from a plurality of desktop environment elements, including taskbar items, desktop icons, and menu items.

In one embodiment, the preferences menu 620 indicates to the user of the source node 100 that the application window 608 is being shared with a user of a consumer node 150. In another embodiment, the preferences menu 620 enables the user to stop a presentation of display data to the user of the consumer node 150. In still another embodiment, the preferences menu 620 enables the user to change the color of the frame displayed around the application window 608 by the third application window 604.

FIG. 6F is a screen shot depicting a display to a user of a consumer node 150 after a user of a source node 100 has closed a shared application window. The screen shot depicts a display of an application window 616 to a user of a consumer node 150 after a user of a source node 100 has closed the first application window. In one embodiment, the application window 616 prevents the display of all desktop environment elements and application windows not selected for sharing by the user of the source node 100. In some embodiments, the application window will show a blank window to the user of the consumer node 150 until the user of the source node 100 selects a new application window for sharing with the consumer node 150.

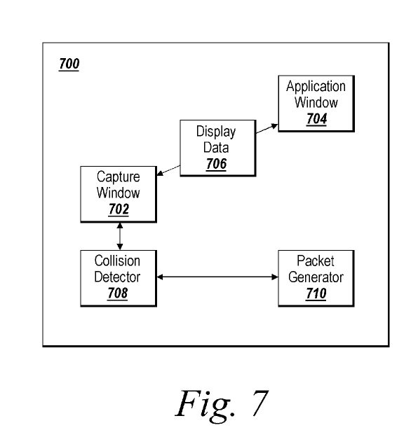

FIG. 7 is a block diagram depicting one embodiment of a node enabling a user to selectively share an application window with a second node. In brief overview, the system 700 includes a capture engine 702, an application window 704, a display data 706, collision detector 708, and a packet generator 710. In one embodiment, the node is a source node 100.

The capture engine 702 identifies a change to a set of display data associated with an application window 704 and storing the set of display data. In some embodiments, a user of the node selects the application window 704 for sharing. In one of these embodiments, the user of the node selects a plurality of application windows 704 for sharing. In another of these embodiments, the user of the node selects a plurality of application windows 704 which together form the entire desktop environment 102. In still another of these embodiments, the user of the node selects a subset of the desktop environment 102 for sharing. In some embodiments, the user of the node explicitly selects the application window 704 for sharing. In other embodiments, where the application window 704 owns other application windows, the user of the node implicitly selects the owned application windows when the user selects the application window 704.

In one embodiment, the node shares the application window 704 by capturing changes to a set of display data and transmitting the changes to the node with whom the user shares the application window 704. In another embodiment, the capture engine 702 captures a section of a screen displayed to the user of the node. The display data representing the second of the screen may be analyzed for changes. In still another embodiment, the capture engine 702 captures a frame in a presentation to the second node.

The collision detector 708, in communication with the capture engine 702, determines whether a change to the set of display data includes display data associated with a second application window, and determines whether the second application window is selected for sharing. In some embodiments, the collision detector 708 determines not to transmit the change to the set of display data due to the association of the display data with the second application window. In one of these embodiments, this determination has the effect of pausing a presentation of display data to the second node, because no changes to the display data are transmitted, and thus, no changes to the application window are transmitted to the second node. In another of these embodiments, the collision detector 708 indicates to the user of the node that no change to the display data associated with the first application window is transmitted to the second node.

In some embodiments, the system includes a third application window displaying a frame around the first application window to indicate to a user of the node that the first application window is selected for sharing. In one of these embodiments, the third application window is associated with the first application window. In another of these embodiments, the first application window is assigned a z-order one level higher than the third application window and no application window has a z-order that would display it between the first application window and the third application window. In still another of these embodiments, the third application window is completely opaque and obscures any window having a lower z-order.

The packet generator 710 generates a data packet representing the change to the set of display data. In some embodiments, the packet generator 710 generates the data packet upon receiving a request to do so from the collision detector 708. In one of these embodiments, the collision detector 708 requests a data packet from the packet generator 710 if a change associated with the first application window comprises data only associated with the first application window. In another of these embodiments, the collision detector 708 requests a data packet from the packet generator if a change associated with the application window includes display data associated with the application window and a second application window selected for sharing. In still another of these embodiments, the packet generator 710 generates the data packet when the collision detector 708 has determined that display data associated with the second application window does not collide with the first application window.

In one embodiment, the packet generator 710 generates a data packet representing the set of display data associated with the first application window at the time the capture engine 702 identified the change to the set of display data. In another embodiment a transmitter receives the data packet from the packet generator and transmits the data packet for presentation to the at least one consumer node 150.

In one embodiment, the packet generator 710 of the source node 100 codes the current state of a dynamic data set, such as screen data, as a set of data packets. In some embodiments, this coding process is straightforward. For example, in the case where the dynamic data set is screen data, data packets may be coded by storing pixel values for a predetermined portion of the screen in the data packet. In some embodiments, the packet generator 710 of the source node 100 compresses the data stored in the data packets. In still other embodiments, the packet generator 710 of the source node 100 encrypts the data stored in the data packets. In still further embodiments, the packet generator 710 of the source node 100 both encrypts and compresses data stored in the data packets. As the dynamic data set changes, the source node updates the set of data packets comprising the current state of the data set.

In some embodiments, the packet generator 710 of the source node 100 transmits the current state of the dynamic data set to a communications service in a bandwidth-adaptive manner. In one embodiment, this is achieved by requiring the source node 100 to possess a transmission token before beginning transmission of the current state of the data set. In this embodiment, the source node 100 and the communications service exchange a limited number of transmission tokens, e.g., five. In other embodiments, the communication service transmits a message to the source node 100 to notify the source node 100 when it can send another data set update.

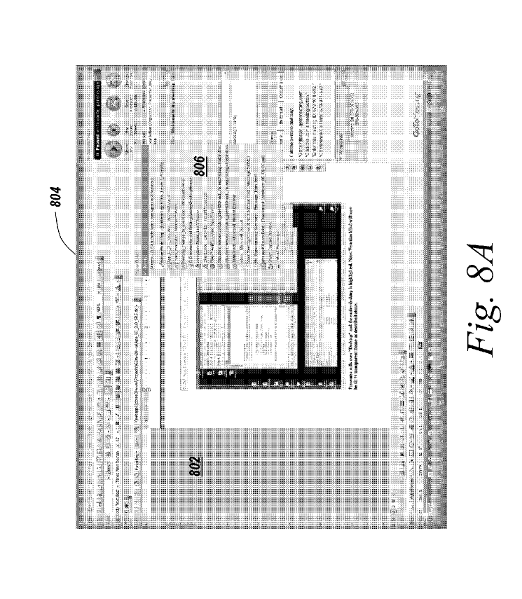

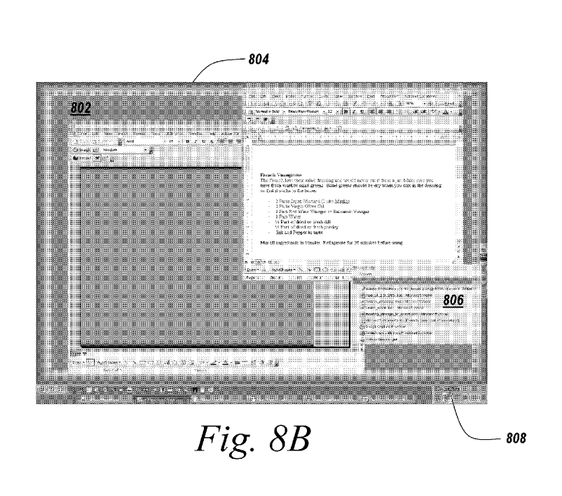

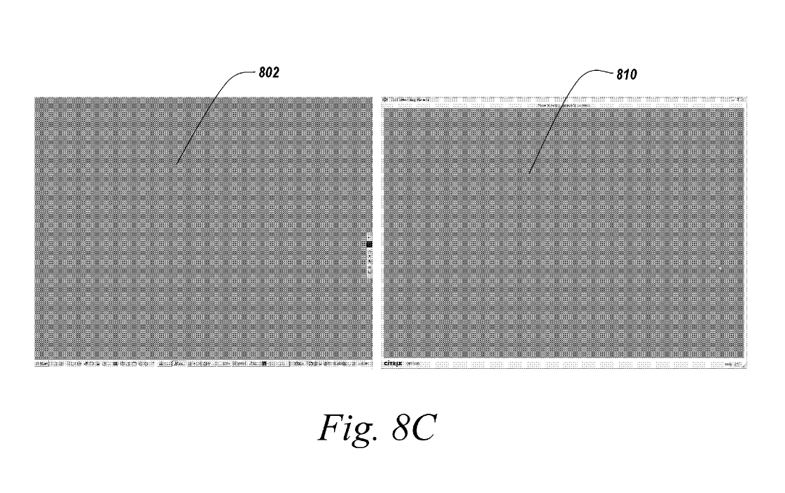

FIG. 8A is a screen shot of an embodiment of a display indicating to a user of a source node 100 that an entire desktop is selected for sharing. In brief overview, the screen shot depicts a first application window 802, an application window 804 associated with the first application window, and a selection menu 806.

In some embodiments, the application window 804 provides feedback to a user of a source node 100 by displaying a frame around the application window 802 when the user selects the application window 802 for sharing with a user of a consumer node 150. In one of these embodiments, depicted in FIG. 8A, the user has selected an option in the selection menu 806 indicating that the application window 802 including an entire desktop environment should be shared with the user of the consumer node 150, and the application window 804 shows a transparent frame around the entire desktop environment. In some of these embodiments, including the entire desktop environment in the application window 802 may enable more accurate troubleshooting or training when sharing the display with the user of the consumer node 150.

FIG. 8B is a screen shot of an embodiment of a display indicating to a user of a source node 100 that a modified form of the entire desktop is selected for sharing. In brief overview, the screen shot depicts an application window 802, an application window 804 associated with the application window, a selection menu 806, and a plurality of desktop environment elements 808.

In one embodiment, when the user of the source node 100 uses the selection menu 806 to select a modified version of the desktop environment, the plurality of desktop environment elements 808 are blocked from presentation to a user of a consumer node 150. In some embodiments depicted in FIG. 8B, this modification of a display of the desktop environment may be referred to as “Clean Desktop.” In one of these embodiments, the application window 804, associated with the application window 802, displays a frame around the application window 802. In another of these embodiments, the plurality of desktop environment elements 808 includes a task bar, desktop icons, and a start menu. In still another of these embodiments, the plurality of desktop environment elements 808 are blocked from display to the consumer node 150 because the source node 100 does not transmit display data representing the plurality of desktop environment elements 808 to the consumer node 150. In one embodiment, the application window 808 displays an empty application window in place of the display of the plurality of desktop environment elements 808.

FIG. 8C is a screen shot of an embodiment of a display to a user of a source node 100 in which the entire desktop is displayed but in which only a modified form of the entire desktop is depicted to a user of a consumer node 150. In brief overview, the screen shot depicts an entire desktop 802 depicted to the user of the source node 100 and a modified desktop 810 to the user of the consumer node 150.

In one embodiment, when the user selects an option from the selection menu 806 to share a modified, “clean desktop” application window 802 with the consumer node 150, the modified desktop 810 is displayed to the user of the consumer node 150. In some embodiments, as depicted in the modified desktop 810 does not display to the user of the consumer node 150 the plurality of desktop environment elements shown in application window 802.

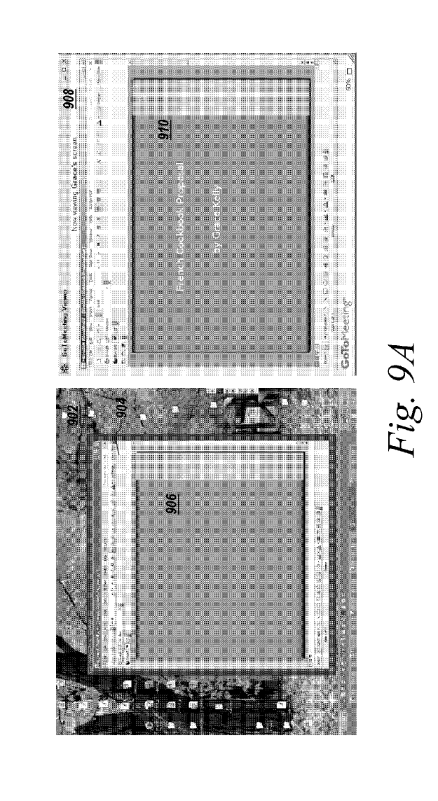

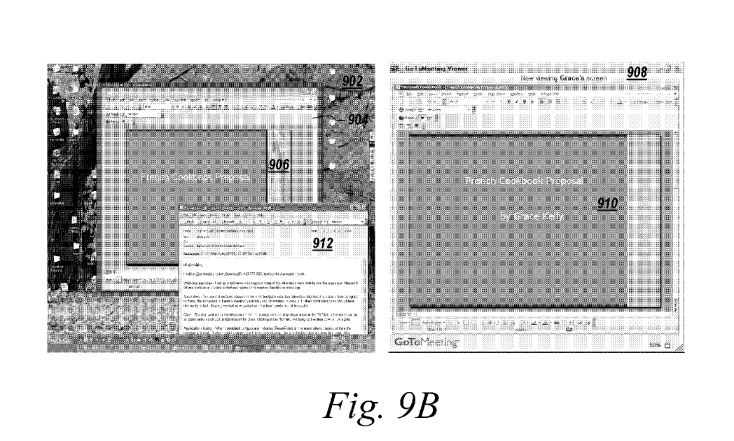

Referring now to FIG. 9A, a screen shot depicts a display of a first application window and a third window associated with the first application window and indicating to a user of a source node 100 that the first application window is selected for sharing and depicting a display of a shared first application window to a user of a consumer node 150. In brief overview, the desktop environment 902 displays application windows to a user of a source node 100 and the desktop environment 908 displays application windows to a user of a consumer node 150.

In one embodiment, the desktop environment 902 includes an application window 906 selected for sharing with the consumer node 150. In another embodiment, the desktop environment 902 includes an application 904 providing a frame around the application window 906 and indicating to the user of the source node 100 that the application window 906 was selected for sharing with the consumer node 150.

In one embodiment, the consumer node 150 receives at least one data packet from the source node 100 and displays on the desktop environment 908 at least one application window 910 representative of an application window 906 displaying on the source node 100. In this embodiment, the user of the source node shares with a user of the consumer node 150 an application window 906 containing a Microsoft Power Point Presentation on a “French Cooking Proposal.”

Referring now to FIG. 9B, a screen shot depicting a display to a user of a source node 100 of a first application window, a second application window obscuring a portion of the first application window, and a third window associated with the first application window and depicting a display to a user of a consumer node 150 of a first application window unobscured by the second application window. In brief overview, the desktop environment 902 displays an obscured application window to a user of a source node 100 and the desktop environment 908 displays an unobscured application window to a user of a consumer node 150.

In one embodiment, a second application window 912 obscures the display on the source node 100 of the shared application window 906 on the desktop environment 902. A user of the source node 100 selected the application window 906 for sharing with the consumer node 150. The application window 904 indicates to the user that the application window 906 is being shared with the consumer node 150 by placing a frame around the application window 904.

In one embodiment, the second application window 912 does not obscure the display on the consumer node 150 of the shared application window 906 on the desktop environment 902. In this embodiment, the source node 100 detected a change to display data associated with the application window 906. The source node 100 also detected that the display data was associated with the second application window 912, which the user had not selected for sharing. The source node 100 determined that the display data associated with the second application window 912 obscured at least some of the application window 906. Upon making these determinations, the source node 100 did not transmit the display data associated with the second application window 912 to the consumer node 150. Since the consumer node 150 did not receive any display data associated with the second application window 912, the consumer node 150 does not display the second application window 912 to the user of the consumer node 150 viewing the desktop environment 908. Therefore, the user of the consumer node 150 views a representation of the first application window 910 unobscured by the second application window 912.

In some embodiments, displaying the application window 910 to the user of the consumer results in pausing the presentation of shared display data. In one of these embodiments, the presentation of shared display data is paused until the intruding application window 912 no longer obscures the application window 910. In another of these embodiments, an indication is displayed to the user of the host node 100 that the presentation is paused. FIG. 9B depicts one of these embodiments in which a text message on the host node 100 reads “paused.”

The following illustrative examples show how the methods and system discussed above can be used to provide selective sharing of an application window. These examples are meant to illustrate and not to limit the invention.

Selective Sharing of an Application Window

In one embodiment, a source node 100 displays a desktop environment 902 to a user of the source node 100. In a conferencing system, the user of the source node 100 determines to share some or all of the application windows that form the desktop environment 902 with a user of a consumer node 150. The user of the source node 100 may employ a conferencing software program to enable sharing and the source node 100 may use a presentation protocol to share display data with the consumer node 150. Presentation protocols include the Independent Computing Architecture (ICA) protocol, available from Citrix Systems, Inc. of Fort Lauderdale, Fla., and the Remote Desktop Protocol (RDP), manufactured by Microsoft Corporation. The user of the source node 100 may select an application window 906 for sharing with the user of the consumer node. The application window 906 may display, for example, a presentation, a word processing document, an internet document such as a web page. When the user of the source node 100 selects the application window 906 for sharing, an application window 904 is associated with the application window 904 and displays a frame around the shared application window 904 to indicate to the user that the application window 904 will be shared with the user of the consumer node 150.

In some embodiments, the consumer node 150 displays to the user of the consumer node 150 an application window 908. In one of these embodiments, the application window 908 displays output from a conferencing software program. In another of these embodiments, an application window 910 displays the shared application window 906. For example, if the user of the source node 100 selected for sharing a presentation document displayed within application window 906, the application window 910 would display to the user of the consumer node 150 the same presentation document.

In one embodiment, many application windows appear on the desktop environment 902. In some embodiments, only the application window 906 is selected for sharing. In other embodiments, a plurality of application windows 906 are selected. In still other embodiments, the entire desktop environment 902 is selected for sharing.

In some embodiments, an application window 912, which has not been selected for sharing, may appear on the desktop environment 902. In one of these embodiments, the application window 912 contains information personal to the user of the source node 100, such as an email or text message. In another of these embodiments, the application window 912 contains sensitive or confidential information that should not be shared with the user of the consumer node 150, such as a word processing document containing confidential company information. In still another of these embodiments, the application window 912 contains information that is irrelevant to the presentation of application window 906 and that would distract or confuse the user of the consumer node 150, such as an additional toolbar or menus.

In one embodiment, the source node 100 determines that the application window 912 should not be displayed to the consumer node 150. The source node 100 may make this determination by detecting that the application window 912 collides with the display of application window 906 and is not selected for sharing. Upon making this determination, the source node determines not to transmit display data representing the application window 912 to the consumer node 150. Since the consumer node 150 does not have the display data needed to display application window 912, the user of the consumer node 150 sees only the application window 906 and not the private, confidential, or irrelevant contents of application window 912.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

What is claimed as new and desired to be protected by Letters Patent of the United States is:

1. A method for selective sharing of an application window, the method comprising the steps of:
(a) selecting, at a source node, a first application window for sharing with at least one consumer node;
(b) determining that a second application window obscures at least some of the first application window; and
(c) displaying, on at least one consumer node, the first application window unobscured by the second application window.

2. The method of claim 1, wherein step (a) further comprises selecting, at a source node, a portion of a desktop environment for sharing with at least one consumer node.

3. The method of claim 1, wherein step (a) further comprises selecting, at the source node, a second application window for sharing with the at least one consumer node, the second application window comprising a window owned by the first application window.

4. The method of claim 1, wherein step (c) further comprises not displaying the second application window to the at least one consumer node.

5. A method for selective sharing of an application window, the method comprising the steps of:
(a) selecting, by a source node, a first application window to share with at least one consumer node;
(b) identifying, by the source node, a change in display data associated with the first application window;
(c) detecting, by the source node, that the change includes display data associated with a second application window;
(d) determining, by the source node, that the second application window is not selected for sharing with the at least one consumer node; and
(e) determining, by the source node, not to generate a data packet representing the change.

6. The method of claim 5, wherein step (a) further comprises selecting a plurality of application windows to share with at least one consumer node, the plurality of application windows forming a desktop environment.

7. The method of claim 5, wherein step (c) further comprises detecting, by the source node, that the second application window has a window identifier different from a window identifier of the first application window.

8. The method of claim 5, wherein step (c) further comprises determining whether a change to display data associated with a second application window collides with a change to display data associated with the application window.

9. The method of claim 5, wherein step (e) further comprises generating the data packet responsive to a determination in step (d) that the change associated with the second application window is selected for sharing with the at least one consumer node.

10. The method of claim 5 further comprising the step of indicating to a user of the source node that the presentation of display data associated with the application window is paused.

11. In a system for selective sharing of an application window, a node comprising:
a capture engine identifying a change to a set of display data associated with an application window and storing the set of display data;
a collision detector, in communication with the capture engine, determining whether a change to the set of display data includes display data associated with a second application window and determining whether the second application window is selected for sharing; and
a packet generator generating a data packet representing the change to the set of display data.

12. The system of claim 11, wherein the capture engine further comprises identifying a change to an application window selected by a user of the node for sharing.

13. The system of claim 11, wherein the capture engine further comprises capturing a section of a screen displayed to a user of the node.

14. The system of claim 11, wherein the capture engine further comprises capturing a frame in a presentation to at least one consumer node.

15. The system of claim 11, wherein the collision detector further comprises requesting a data packet from the packet generator if a change associated with the application window comprises data associated with the application window.

16. The system of claim 11, wherein the collision detector further comprises requesting a data packet from the packet generator if a change associated with the application window comprises display data associated with the application window and a second application window selected for sharing.

17. The system of claim 11, wherein the collision detector further comprises indicating to a user of the node that no change to the display data associated with the first application window is transmitted to the at least one consumer node.

18. The system of claim 11, wherein the packet generator further comprises generating a data packet representing the set of display data associated with the first application window at the time the capture engine identified the change to the set of display data.

19. The system of claim 11, wherein the packet generator further comprises generating the data packet responsive to a request from the collision detector.

20. The system of claim 11, wherein the packet generator further comprises generating the data packet responsive to a determination by the collision detector that the second application window is selected for sharing.

21. The system of claim 11 further comprising a transmitter receiving from the packet generator a data packet and transmitting the data packet for presentation to the at least one consumer node.

22. The system of claim 11, wherein the second application window is owned by the first application window.

23. The system of claim 11 further comprising a third application window displaying a frame around the first application window to indicate to a user of the node that the first application window is selected for sharing.

24. The system of claim 11 further comprising a third application window associated with the first application window and blocking the presentation of a desktop environment on which the first application window is displayed.
